(19) United States
(12) Patent Application Publication
(10) Pub. No.: US 2009/0041647 A1
(43) Pub. Date: Feb. 12, 2009

(54) Method for Producing Nanoparticulate Lanthanoide/Boron Compounds or Solid Substance Mixtures Containing Nanoparticulate Lanthanoide/Boron Compounds

(75) Inventors: Julian Prolss, Worms (DE); Kirill Bramnik, Mannheim (DE); Norbert Wagner, Mutterstadt (DE); Gero Nordmann, Heidelberg (DE); Markus Hammermann, Dossenheim (DE); Alexander Benohr, Speyer (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/917,650

(22) PCT Filed: Jun. 14, 2006
(86) PCT No.: PCT/EP2006/063235

§ 371 Date: Dec. 14, 2007

(30) Foreign Application Priority Data
Jun. 17, 2005 (DE) 102005028463.9

(51) Int. Cl. C01F 17/00

(52) U.S. Cl. 423/263

(57) ABSTRACT

The present invention relates to a process for preparing essentially isometric nanoparticulate lanthanide-boron compounds or solid mixtures comprising essentially isometric nanoparticulate lanthanide-boron compounds, which comprises
a) mixing i) one or more lanthanide compounds selected from the group consisting of lanthanide hydroxides, lanthanide hydrides, lanthanide chalcogenides, lanthanide halides, lanthanide borates and mixed compounds of the lanthanide compounds mentioned,
   ii) one or more compounds selected from the group consisting of crystalline boron, amorphous boron, boron carbides, boron hydrides and boron halides and
   iii) if appropriate one or more reducing agents selected from the group consisting of hydrogen, carbon, organic compounds, alkaline earth metals and alkaline earth metal hydrides
   dispersed in an inlet carrier gas with one another,
b) reacting the mixture of the components i), ii) and, if appropriate, iii) in the inert solvent by means of thermal treatment within a reaction zone,
c) subjecting the reaction product obtained by means of thermal treatment in step b) to rapid cooling and
d) subsequently separating off the reaction product which has been cooled in step c),
   with the cooling conditions in step c) being selected so that the reaction product consists of essentially isometric nanoparticulate lanthanide-boron compounds or comprises essentially isometric nanoparticulate lanthanide-boron compounds.

The present invention relates to a process for preparing essentially isometric nanoparticulate lanthanoid-boron compounds or solid mixtures comprising essentially isometric nanoparticulate lanthanoid-boron compounds, which comprises

a) mixing i) one or more lanthanoid compounds selected from the group consisting of lanthanoid hydroxides, lanthanoid hydrides, lanthanoid chalcogenides, lanthanoid halides, lanthanoid borates and mixed compounds of the lanthanoid compounds mentioned,

b) ii) one or more compounds selected from the group consisting of crystalline boron, amorphous boron, boron carbides, boron hydrides and boron halides
and
iii) if appropriate one or more reducing agents selected from the group consisting of hydrogen, carbon, organic compounds, alkaline earth metals and alkaline earth metal hydrides
dispersed in an inlet carrier gas with one another,

c) reacting the mixture of the components i), ii) and, if appropriate, iii) in the inert solvent by means of thermal treatment within a reaction zone,

d) subjecting the reaction product obtained by means of thermal treatment in step b) to rapid cooling and

e) subsequently separating off the reaction product which has been cooled in step c),
with the cooling conditions in step c) being selected so that the reaction product consists of essentially isometric nanoparticulate lanthanoid-boron compounds or comprises essentially isometric nanoparticulate lanthanoid-boron compounds.

Nanoparticulate lanthanoid-boron compounds, in particular lanthanum hexaboride nanoparticles, display excellent absorption of radiation in the near and far infrared. Accordingly, there are a variety of processes for preparing such compounds, in particular lanthanum hexaboride, the by far most widely used lanthanoid-boron compound.

While most methods of preparation are based on conventional high-temperature reaction of suitable lanthanoid and boron precursor compounds and milling of the coarse primary products formed, processes which directly give nanoparticulate lanthanoid-boron compounds are also known.

Thus, according to JP-B 06-039326, nanoparticulate metal boride is obtained by vaporization of the boride of a metal of group Ia, IIa, IIIa, IVa, Va or VIa of the Periodic Table or by vaporization of a mixture of the corresponding metal with boron in a hydrogen or hydrogen/inert gas plasma and subsequent condensation.

The preparation of nanoparticulate metal borides by reaction of the metal powder and/or metal boride powder with boron powder in the plasma of an inert gas is described by JP-A 2003-261323.

Both these plasma processes start out from the corresponding metals or metal borides which are themselves usually obtainable only by means of complicated and thus generally energy-intensive and costly processes. Thus, for example, the lanthanoid metals are usually prepared by the lanthanoid halides by means of melt electrolysis, since the former display highly electropositive behavior.

It is thus an object of the invention to provide a method of preparing lanthanoid-boron compounds which makes it possible to start out directly from inexpensive lanthanoid compounds.

We have accordingly found the process described at the outset.

In the process of the invention, it is possible to use one or more lanthanoid compounds selected from the group consisting of lanthanoid hydroxides, lanthanoid hydrides, lanthanoid chalcogenides, lanthanoid halides, lanthanoid borates and mixed compounds of the lanthanoid compounds mentioned as component i). Suitable lanthanoid hydroxides are, in particular, the hydroxides of the trivalent lanthanoids Ln(OH)₃ (in accordance with customary language usage, a lanthanoid element which is not specified further or yttrium will hereinafter be abbreviated as “Ln”), suitable lanthanoid hydrides are the compounds LnH₂ and LnH₃, suitable lanthanoid chalcogenides are the compounds LnS, LnSe and LnTe, in particular the compounds Ln₂O₃ and Ln₂S₃, suitable lanthanoid halides are, in particular, LnF₃, LnCl₃, LnBr₃ and LnI₃ and suitable lanthanoid borates are, in particular, LnBO₃, Ln₃BO₆ and Ln(BO₂)₃. Furthermore, suitable mixed compounds are LnO(OH), LnOF, LnOCl, LnOBr, LnSF, LnSCl, LnSBr and Ln₂O₂S.

Preference is given to using one or more lanthanoid compounds selected from the group consisting of lanthanoid hydroxides, lanthanoid chalcogenides, lanthanoid halides and mixed compounds of the lanthanoid compounds mentioned, particularly preferably one or more lanthanoid compounds selected from the group consisting of lanthanoid hydroxides, lanthanoid oxides, lanthanoid chlorides, lanthanoid bromides and mixed compounds of the lanthanoid compounds mentioned, as component i) in the process of the invention. Particularly preferred lanthanoid compounds are, in particular, the abovementioned compounds of the trivalent lanthanoids Ln(OH)₃, Ln₂O₃, LnCl₃, LnBr₃, LnO(OH), LnOCl and LnOBr.

Very particular preference is given to using one or more lanthanum compounds as component i) in the process of the invention, with the above preferences also applying to the lanthanum compounds. Especially suitable lanthanum compounds are La(OH)₃, La₂O₃, LaCl₃, LaBr₃, LaO(OH), LaOCl and LaOBr.

As component ii) in the process of the invention, it is possible to use one or more compounds selected from the group consisting of crystalline boron, amorphous boron, boron carbides, boron hydrides and boron halides. Among boron carbides, particular mention may be made of B₄C; among boron hydrides, particular mention may be made of B₂H₆; and among boron halides, particular mention may be made of boron trifluoride, boron trichloride and boron tribromide.

In the process of the invention and its preferred embodiments, preference is given to using one or more compounds selected from the group consisting of crystalline boron, amorphous boron and boron halides, particularly preferably one or more compounds selected from the group consisting of crystalline boron, amorphous boron, boron trichloride and boron tribromide, as component ii).

As component iii) in the process of the invention, it is possible to use, if appropriate, one or more reducing agents selected from the group consisting of hydrogen, carbon, organic compounds, alkaline earth metals and alkaline earth metal hydrides.

Organic compounds as reducing agents are, for example, gaseous or liquid hydrocarbons. Mention may here be made of aliphatic compounds having from one to typically about 20 carbon atoms, for example alkanes such as methane, ethane, propane, butane, isobutane, octane and isooctane, alkenes and alkadienes, e.g. ethylene, propylene, butene, isobutene and butadiene, and alkynes such as acetylene and propyne, cycloaliphatic compounds having from three to typically 20 carbon atoms, for example cycloalkanes such as cyclopropane, cyclobutane, cyclopentane, cyclohexane, cycloheptane and cyclooctane, cycloalkenes and cycloalkadienes, e.g. cyclopropene, cyclobutene, cyclopentene, cyclohexene, cycloheptene, cyclooctene and cyclooctadiene and also aromatic, optionally more highly fused hydrocarbons having from 6 to typically 20 carbon atoms, for example benzene, naphthalene and anthracene. Both the cycloaliphatic compounds and the aromatic hydrocarbons can also be substituted by one or more aliphatic radicals or be fused with cycloaliphatic compounds. For example, suitable reducing agents which may be mentioned here are toluene, xylene, ethylbenzene, tetralin, decalin and dimethyinaphthalene. Furthermore, mixtures of the abovementioned aliphatic, cycloaliphatic and aromatic compounds can also be used as possible reducing agents. Examples which may be mentioned here are mineral oil products such as petroleum ether, light gasoline, medium gasoline, solvent naphtha, kerosene, diesel oil and heating oil.

Further reducing agents which can be used are organic liquids, for example alcohols such as methanol, ethanol, propanol, isopropanol, butanol, isobutanol, sec-butanol, pentanol, isopentanol, neopentanol and hexanol, glycols such as 1,2-ethylene glycol, 1,2- and 1,3-propylene glycol, 1,2-, 2,3- and 1,4-butylene glycol, diethylene and triethylene glycol and dipropylene and tripropylene glycol, ethers such as dimethyl ether, diethyl ether and methyl tert-butyl ether, 1,2-ethylene glycol monomethyl and dimethyl ether, 1,2-ethylene glycol monoethyl and diethyl ether, 3-methoxypropanol, 3-isopropoxypropanol, tetrahydrofuran and dioxane, ketones such as acetone, methyl ethyl ketone and diacetone alcohol, esters such as methyl acetate, ethyl acetate, propyl acetate or butyl acetate, and also natural oils such as olive oil, soybean oil and sunflower oil.

With regard to the dispersion of the components i), ii) and, if appropriate, iii) in the inert carrier gas, their physical state is of importance.

In the case of solids, dispersion of the components i), ii) and, if appropriate, iii) can be brought about by means of appropriate apparatuses known to those skilled in the art, e.g. by means of brush feeders or screw feeders, and subsequent transport in suspended form in a stream of gas. The solids then preferably form aerosols in the carrier gas, in which the particle sizes of the solids can be in the same range as the nanoparticulate lanthanoid-boron compounds obtainable by the process of the invention. The mean aggregate size of the solid components is typically from 0.1 to 500 μm, preferably from 0.1 to 50 μm, particularly preferably from 0.5 to 5 μm. When the mean aggregate sizes are larger, there is a risk of incomplete conversion into the gas phase, so that such larger particles are unavailable or only incompletely available for the reaction. A surface reaction on incompletely vaporized particles may also lead to them becoming passivated.

In the case of liquids, dispersion can be brought about in the form of vapor or liquid droplets, likewise with the aid of appropriate apparatuses known to those skilled in the art. These are, for example, evaporators such as thin film evaporators or flash evaporators, a combination of atomization and gas stream evaporators, vaporization in the presence of an exothermic reaction (cold flame), etc. Incomplete reaction of the atomized liquid starting material generally does not have to be feared as long as the liquid droplets have the particle dimensions of less than 50 μm which are typical of aerosols.

The various components i), ii) and, if appropriate, iii) can be present in mixed form in the carrier gas, but they can also be introduced into separate carrier gas streams which are advantageously mixed before they enter the reaction zone.

Furthermore, solid components i), ii) and/or, if appropriate, iii) can be transferred into the gas phase in the presence of the carrier gas before they enter the reaction zone. This can be brought about by, for example, the same methods which are used in step b) of the process of the invention for the thermal treatment of the mixture of the components i), ii) and, if appropriate, iii) in the reaction zone. Thus, the components i), ii) and, if appropriate, iii) can be vaporized, preferably individually, and introduced into the carrier gas by means of, in particular, microwave plasma, electric arc plasma, convection/radiation heating or autothermal reaction conditions.

As inert carrier gas, it is usual to use a noble gas such as helium or argon or a noble gas mixture, for example of helium and argon. In specific cases, it is also possible to use nitrogen, if appropriate in admixture with the abovementioned noble gases, as carrier gas, but in this case at higher temperatures and, depending on the nature of the components i), ii) and/or, if appropriate, iii), the formation of nitrides has to be reckoned with.

If solid components i), ii) and, if appropriate, iii) are used and are transported separately by the carrier gas into the reaction zone, the loading of the carrier gas is usually in each case from 0.01 to 5.0 g/l, preferably from 0.05 to 1 g/l. If solid components i), ii) and, if appropriate, iii) are used and are transported as a mixture into the reaction zone by the carrier gas, the total loading of the carrier gas with the solid components i), ii) and, if appropriate, iii) is usually from 0.01 to 2.0 g/l, preferably from 0.05 to 0.5 g/l.

In the case of liquid and gaseous components i), ii) and, if appropriate, iii), higher loadings than those mentioned above are generally possible. The loadings suitable for the respective process conditions can usually be determined easily by means of appropriate preliminary experiments.

The ratio of component i) to component ii) generally depends essentially on the stoichiometry of the desired lanthanoid-boron compound. Since the lanthanoid hexaboride is generally formed as stable phase or is to be obtained as reaction product, the one or more lanthanoid compounds of the component i) and the one or more boron compounds of the component ii) are used in a molar ratio of Ln:B of about 1:6. If the presence of a by-product which consists of one of the reactants (i.e. component i) or component ii)) or a compound formed from the reactant in the reaction product is to be reduced or prevented, it can be advantageous to use the counterreactant (i.e. component ii) or component i), respectively) in an appropriate excess.

The components i), ii) and, if appropriate, iii) introduced into the reaction zone are there reacted with one another in step c) of the process of the invention by means of thermal treatment, i.e. heating to high temperatures, using, in particular, microwave plasma, electric arc plasma, convection/radiation heating, autothermal reaction conditions or a combination of the abovementioned methods.

Appropriate procedures and process conditions for bringing about heating of the components in the reaction zone by means of microwave plasma, electric arc plasma, convection/radiation heating, autothermal reaction conditions or a combination of the abovementioned methods are adequately known to those skilled in the art.

To obtain essentially isometric, i.e. essentially uniform in terms of their size and morphology, nanoparticulate lanthanoid-boron compounds or corresponding solid mixtures comprising essentially isometric nanoparticulate lanthanoid-boron compounds, it is, as is generally known to those skilled in the art, advantageous to stabilize the conditions in the reaction zone both over space and over time. This ensures that the components i), ii) and, if appropriate, iii) are subjected to virtually identical conditions during the reaction and thus react to form uniform product particles.

The residence time of the mixture of the components i), ii) and, if appropriate, iii) in the reaction zone is usually from 0.002 s to 2 s, typically from 0.005 s to 0.2 s.

When the reaction is carried out autothermally, mixtures of hydrogen and halogen gas, in particular chlorine gas, are preferably used for producing the flame. Furthermore, the flame can also be produced using mixtures of methane, ethane, propane, butanes, ethylene or acetylene or mixtures of the abovementioned gases with oxygen gas, with the latter preferably being used in a substoichiometric amount in order to obtain reducing conditions in the reaction zone of the autothermal flame.

In a preferred embodiment, the thermal treatment is carried out by means of microwave plasma.

As gas or gas mixture for producing the microwave plasma, it is usual to use a noble gas such as helium or argon or a noble gas mixture, for example of helium and argon.

Furthermore, use is generally made of a protective gas which forms a gas layer between the wall of the reactor used for producing the microwave plasma and the reaction zone, with the latter corresponding essentially to the region in which the microwave plasma is present in the reactor.

The power introduced into the microwave plasma is generally in the range from a few kW to a number of 100 kW. Higher power microwave plasma sources can in principle also be used for the synthesis. Furthermore, a person skilled in the art will be familiar with the procedure for producing a steady-state plasma flame, in particular in respect of microwave power introduced, gas pressure, amounts of plasma gas and protective gas.

After nucleation, nanoparticulate primary particles are firstly formed during the reaction in step b) and these generally undergo further particle growth by means of coagulation and coalescence processes. Particle formation and particle growth typically occur in the entire reaction zone and can also continue after leaving the reaction zone until rapid cooling. If further solid products are formed during the reaction in addition to the desired lanthanoid-boron compounds, the different primary particles formed can also agglomerate with one another, forming nanoparticulate solid mixtures. If the formation of a plurality of different solids occurs at different times during the reaction, encased products in which the primary particles of one product formed first are surrounded by layers of one or more other products can also be formed. These agglomeration processes can be controlled, for example, by means of the chemical nature of the components i), ii) and, if appropriate, iii) in the carrier gas, the loading of the carrier gas with the components, the presence of more than one of the components i), ii) and, if appropriate, iii) in the same carrier gas stream and their mixing ratio therein, the conditions of the thermal treatment in the reaction zone and also the type and point in time of the cooling of the reaction product occurring in step c).

The cooling in step c) can be effected by means of direct cooling (quenching), indirect cooling, expansion cooling (adiabatic expansion) or a combination of these cooling methods. In direct cooling, a coolant is brought into direct contact with the hot reaction product in order to cool the latter. In the case of indirect cooling, heat energy is withdrawn from the reaction product without it coming into direct contact with a coolant. Indirect cooling generally makes it possible for the heat energy transferred to the coolant to be utilized effectively. For this purpose, the reaction product can be brought into contact with the exchange surfaces of a suitable heat exchanger. The heated coolant can, for example, be used for heating/preheating or vaporizing the solid, liquid or gaseous components i), ii) and, if appropriate, iii).

The cooling conditions in step c) are selected so that the reaction product consists of essentially isometric nanoparticulate lanthanoid-boron compounds or comprises essentially isometric nanoparticulate lanthanoid-boron compounds. In particular, care has to be taken to ensure that no primary particles can deposit on hot surfaces of the reactor used and are thus subjected, in particular, to thermal conditions which promote further, directed growth of these primary particles.

The process of the invention is preferably carried out in such a way that the reaction product obtained is cooled to a temperature in the range from 1800° C. to 20° C. in step c).

To separate off the reaction product obtained in step c), it is subjected to at least one separation and/or purification step in step d). Here, the nanoparticulate lanthanoid-boron compounds formed are isolated from the remaining constituents of the reaction product. Customary separation apparatuses known to those skilled in the art, for example filters, cyclones, dry or wet electrostatic precipitators or Venturi scrubbers, can be used for this purpose. If appropriate, the nanoparticulate compounds formed can be fractionated during the separation, e.g. by fractional precipitation. It is in principle desirable to obtain lanthanoid-boron compounds without by-products or at least with only small proportions of by-products by means of appropriate process conditions, in particular by selection of suitable starting materials.

The particle size of the nanoparticulate lanthanoid-boron compounds prepared by the process of the invention is usually in the range from 1 to 500 nm, in particular in the range from 2 to 150 nm. The nanoparticulate lanthanoid-boron compounds prepared by the process of the invention have a particle size distribution whose standard deviation σ is less than 1.5. If a solid by-product is formed, a bimodal distribution can occur, with the standard deviation of the lanthanoid-boron compounds a once again being less than 1.5.

The process of the invention can be carried out at any pressure. It is preferably carried out at pressures in the range from 10 hPa to 5000 hPa. In particular, the process of the invention can also be carried out at atmospheric pressure.

The process of the invention is suitable for the continuous preparation of essentially isometric nanoparticulate lanthanoid-boron compounds under essentially steady-state conditions. Important requirements in this process are rapid energy input at a high temperature level, generally uniform residence times of the starting materials and the reaction product under the conditions in the reaction zone and rapid cooling (“shock-cooling”) of the reaction product in order to prevent agglomeration and, in particular, directed growth of the nanoparticulate primary particles formed.

### EXAMPLE 1

A finely divided mixture of 40% by weight of amorphous boron and 60% by weight of La₂O₃ (molar ratio of La:B=1:10) is fed at a rate of 20 g/h in an Ar carrier gas stream (180 l/h) into a microwave plasma. In addition, a stream of 3.6 standard m³/h of a gas mixture of 75% by volume of Ar, 10% by volume of hydrogen and 15% by volume of He is introduced into the plasma. The plasma is generated by a power input of 30 kW. After the reaction, the reaction gas is quenched very rapidly and the particles formed are separated off. A mixture comprising predominantly B₂O₃ having a mean particle size of about 30 nm and LaB₆ having a mean particle size of about 100 nm and having a bimodal particle size distribution is obtained as reaction product.

### EXAMPLE 2

A finely divided mixture of 39% by weight of amorphous boron and 61% by weight of CeO₂ is fed at a rate of 20 g/h in an Ar carrier gas stream (180 l/h) into a microwave plasma. In addition, a stream of 3.6 standard m³/h of a gas mixture of 75% by volume of Ar, 10% by volume of hydrogen and 15% by volume of He is introduced into the plasma. The plasma is generated by a power input of 30 kW. After the reaction, the reaction gas is quenched very rapidly and the particles formed are separated off. A mixture comprising predominantly B₂O₃ having a mean particle size of about 30 nm and CeB₆ having a mean particle size of about 100 nm and having a bimodal particle size distribution is obtained as reaction product.

### EXAMPLE 3

A finely divided mixture of 36% by weight of amorphous boron and 64% by weight of CeF₃ is fed at a rate of 20 g/h in an Ar carrier gas stream (180 l/h) into a microwave plasma. In addition, a stream of 3.6 standard m³/h of a gas mixture of 75% by volume of Ar, 10% by volume of hydrogen and 15% by volume of He is introduced into the plasma. The plasma is generated by a power input of 30 kW. After the reaction, the reaction gas is quenched very rapidly and the particles formed are separated off. CeB₆ having a mean particle size of about 100 nm is obtained as reaction product.

### EXAMPLE 4

A finely divided mixture of 39% by weight of amorphous boron and 61% by weight of Nd₂O₃ is fed at a rate of 20 g/h in an Ar carrier gas stream (180 l/h) into a microwave plasma. In addition, a stream of 3.6 standard m³/h of a gas mixture of 75% by volume of Ar, 10% by volume of hydrogen and 15% by volume of He is introduced into the plasma. The plasma is generated by a power input of 30 kW. After the reaction, the reaction gas is quenched very rapidly and the particles formed are separated off. A mixture comprising predominantly B₂O₃ having a mean particle size of about 30 nm and NdB₆ having a mean particle size of about 100 nm and having a bimodal particle size distribution is obtained as reaction product.

### EXAMPLE 5

A finely divided mixture of 35% by weight of amorphous boron and 65% by weight of NdF₃ is fed at a rate of 20 g/h in an Ar carrier gas stream (180 l/h) into a microwave plasma. In addition, a stream of 3.6 standard m³/h of a gas mixture of 75% by volume of Ar, 10% by volume of hydrogen and 15% by volume of He is introduced into the plasma. The plasma is generated by a power input of 30 kW. After the reaction, the reaction gas is quenched very rapidly and the particles formed are separated off. NdB₆ having a mean particle size of about 100 nm is obtained as reaction product.

### EXAMPLE 6

A finely divided mixture of 49% by weight of amorphous boron and 51% by weight of Y₂O₃ is fed at a rate of 20 g/h in an Ar carrier gas stream (180 l/h) into a microwave plasma. In addition, a stream of 3.6 standard m³/h of a gas mixture of 75% by volume of Ar, 10% by volume of hydrogen and 15% by volume of He is introduced into the plasma. The plasma is generated by a power input of 30 kW. After the reaction, the reaction gas is quenched very rapidly and the particles formed are separated off. A mixture comprising predominantly B₂O₃ having a mean particle size of about 30 nm and YB₆ having a mean particle size of about 100 nm and having a bimodal particle size distribution is obtained as reaction product.

### EXAMPLE 7

A finely divided mixture of 36% by weight of amorphous boron and 64% by weight of YCl₃ is fed at a rate of 20 g/h in an Ar carrier gas stream (180 l/h) into a microwave plasma. In addition, a stream of 3.6 standard m³/h of a gas mixture of 75% by volume of Ar, 10% by volume of hydrogen and 15% by volume of He is introduced into the plasma. The plasma is generated by a power input of 30 kW. After the reaction, the reaction gas is quenched very rapidly and the particles formed are separated off. YB₆ having a mean particle size of about 100 nm is obtained as reaction product.

### EXAMPLE 8

Finely divided LaCl₃ together with 45 g/h of a B₂H₆ stream (molar ratio of La:B=1:10) is fed at a rate of 80 g/h in an Ar/H₂ carrier gas stream (640 l/h, molar ratio of Ar:H₂=10:1) into an electric arc plasma. In addition, an Ar stream of 12 standard m³/h is introduced into the plasma. The plasma is generated by a power input of 70 kW. After the reaction, the reaction gas is quenched very rapidly and the particles formed are separated off. A mixture comprising predominantly B₂O₃ having a mean particle size of about 20 nm and LaB₆ having a mean particle size of about 70 nm and having a bimodal particle size distribution is obtained as reaction product.

1. A process for preparing essentially isometric nanoparticulate lanthanide-boron compounds or solid mixtures comprising essentially isometric nanoparticulate lanthanide-boron compounds, which comprises
a) mixing i) one or more lanthanide compounds selected from the group consisting of lanthanide hydroxides, lanthanide hydrides, lanthanide chalcogenides, lanthanide halides, lanthanide borates and a mixture thereof,
ii) one or more compounds selected from the group consisting of crystalline boron, amorphous boron, boron carbides, boron hydrides and boron halides and
iii) if appropriates one or more reducing agents selected from the group consisting of hydrogen, carbon, organic compounds, alkaline earth metals and alkaline earth metal hydrides,
dispersed in an inert carrier gas with one another,
b) reacting the mixture of the components i), ii) and, if appropriate, iii) in the inert solvent by means of thermal treatment within a reaction zone,
c) subjecting the reaction product obtained by means of thermal treatment in step b) to rapid cooling, and
d) subsequently separating off the reaction product which has been cooled in step c),
with the cooling conditions in step c) being selected so that the reaction product consists of essentially isometric nanoparticulate lanthanide-boron compounds or comprises essentially isometric nanoparticulate lanthanide-boron compounds.

2. The process according to claim 1, wherein the thermal treatment of the mixture of the components i), ii) and, if appropriate, iii) in the inert carrier gas is effected by means of a microwave plasma, electric arc plasma, convection/radiation heating, autothermal reaction conditions or a combination of the methods in step b).

3. The process according to claim 1, wherein the thermal treatment of the mixture of the components i), ii) and, if appropriate, iii) in the inert carrier gas is effected by means of a microwave plasma in step b).

4. The process according to claim 1, wherein the reaction product obtained is cooled to a temperature in the range from 1800° C. to 20° C. in step c).

5. The process according to claim 1, wherein one or more lanthanide compounds selected from the group consisting of lanthanide hydroxides, lanthanide chalcogenides, lanthanide halides and a mixture thereof is/are used as component i).

6. The process according to claim 1, wherein one or more lanthanide compounds selected from the group consisting of lanthanide hydroxides, lanthanide oxides, lanthanide chlorides, lanthanide bromides and a mixture thereof is/are used as component i).

7. The process according to claim 1, wherein one or more lanthanum compounds is/are used as component i).

8. The process according to claim 1, wherein one or more compounds selected from the group consisting of crystalline boron, amorphous boron and boron halides is/are used as component ii).

9. The process according to claim 1, wherein one or more compounds selected from the group consisting of crystalline boron, amorphous boron, boron trichloride and boron tribromide is/are used as component ii).

10. The process according to claim 1 carried out in a pressure range from 500 hPa to 2000 hPa.
